(19) United States
(12) Patent Application Publication
(10) Pub. No.: US 2006/0095787 A1
(43) Pub. Date: May 4, 2006

(54) Communication networks and methods and computer program products for tracking network activity thereon and facilitating limited use of the collected information by external parties

(76) Inventor: Jeffrey A. Aaron, Atlanta, GA (US)

Correspondence Address: MYERS BIGEL SIBLEY & SAJOVEC, P.A., P.O. BOX 37428, RALEIGH, NC, 27627, US

(21) Appl. No.: 10/978,624

(22) Filed: Nov. 1, 2004

(51) Int. Cl. H04K 1/00

(52) U.S. Cl. 713/184

(57) ABSTRACT

A communication network is operated by associating a pseudonym with a user of the communication network. The user's activities are monitored on the communication network and associated with the pseudonym.

### FIELD OF THE INVENTION

The present invention relates to communication networks and methods of operating the same, and, more particularly, to tracking user activity on communication networks.

### BACKGROUND OF THE INVENTION

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the World Wide Web (WWW) service facility, which is a client/server-based facility that includes a large number of servers (computers connected to the Internet) on which Web pages or files reside, as well as clients (Web browsers), which interface users with the Web pages. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

Due to the public accessibility of modern communications networks, users of these networks may be concerned with security and/or privacy. Service providers, however, may desire to profile and/or keep track of customer actions and activities for many valid reasons. These reasons may include enabling the provider to more efficiently, effectively, and/or satisfactorily offer the customer additional services. Even with existing services already provided to the customer, tracking and profiling that help the provider know the customer better may enable those existing services to be provided in an improved manner. In fact, some services and particularly some new Internet Protocol (IP) based or network-provided services may require tracking and/or profiling of customers to properly function. Customers, however, may be increasingly concerned with privacy, and, in many cases, may not want such information to be collected because it may be associated with them and subsequently used in ways that they may consider annoying or even harmful. Current methods of tracking and profiling typically associate the collected information directly with customer identities or other customer information, which could in theory or practice by associated with the individual customer, such that the customer must unfortunately rely entirely on provider promises that annoying or harmful uses will not be allowed or will be limited. This approach may be both confusing and/or insufficient.

### SUMMARY OF THE INVENTION

According to some embodiments of the present invention, a communication network is operated by associating a pseudonym with a user of the communication network. The user's activities are monitored on the communication network and associated with the pseudonym.

In other embodiments of the present invention, associating the pseudonym with the user comprises hashing identification information of the user to generate the pseudonym.

In other embodiments of the present invention, hashing the identification information comprises hashing the identification information with salt data to generate the pseudonym.

In still other embodiments of the present invention, the user's activities are tracked by obtaining an identification of authorized activities to be tracked from the user and tracking those authorized activities on the communication network.

In still other embodiments of the present invention, the user's activities are tracked by associating keywords with the user's activities on the communication network. The keywords are hashed and the hashes of the keywords are associated with the pseudonym.

In still other embodiments of the present invention, the keywords are hashed with salt data.

In still other embodiments of the present invention, a request is received for information on the user's activities that includes keywords of interest from a requester. The keywords of interest are hashed and a comparison of the hashes of the keywords of interest is made with the hashes of the keywords associated with the pseudonym. A determination is made if any of the keywords of interest correspond to any of the keywords associated with the user's activities based on the foregoing comparison. The requester is provided with an indication of which keywords of interest correspond to any of the keywords associated with the user's activities.

In still other embodiments of the present invention, a request for information on the user's activities is received from a requester. A distribution of the instances of the keywords associated with the user's activities is evaluated to identify those keywords having a frequency that is higher than a threshold. The requester is provided with those keywords having the frequency that is higher than the threshold, a preference list of keywords associated with the user, and/or pre-identified keywords that are associated with the user's activities.

In still other embodiments of the present invention, a privacy policy is obtained from the user. The privacy policy is associated with the pseudonym and communications to the pseudonym, including requests for information on the user's activities and/or other indications of user activities, that violate the privacy policy are blocked.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention;

FIG. 2 illustrates a data processing system that may be used to implement various servers of the communication network of FIG. 1 in accordance with some embodiments of the present invention; and

FIGS. 3-5 are flowcharts that illustrate operations of tracking and profiling network activities of a user and facilitating limited use of the collected information by external parties in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

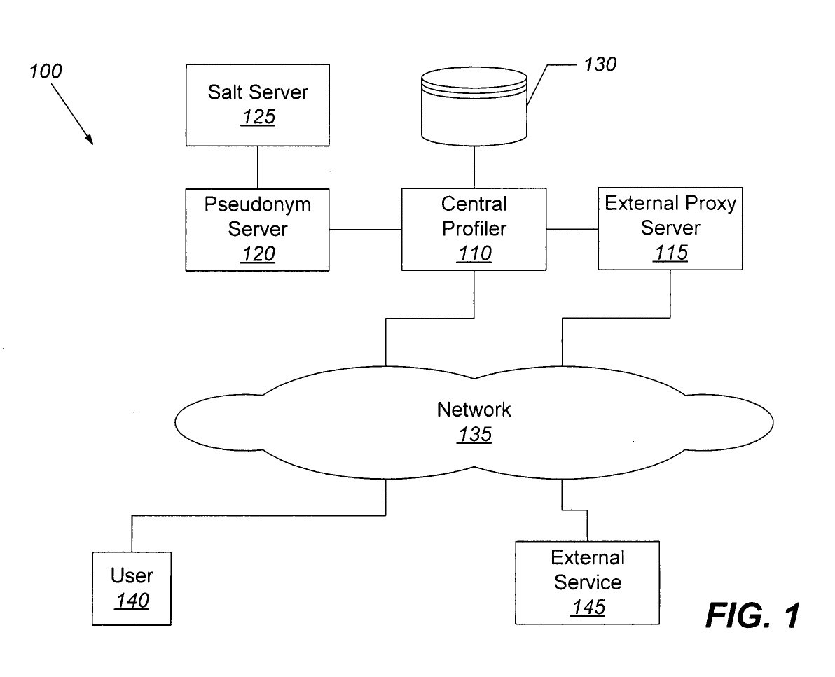

Referring now to FIG. 1, an exemplary network architecture 100 for tracking and profiling network activities of a user and facilitating limited use of the collected information by external parties, in accordance with some embodiments of the present invention, comprises a central profiler 110, an external proxy server 115, a pseudonym server 120, a salt server 125, and a database 130 that are connected to a network 135 as shown. A user 140 and an external service 145 are also connected to the network 135 and use the network 135 to communicate with each other. The network 135 may represent a global network, such as the Internet, or other publicly accessible network. The network 135 may also, however, represent a wide area network, a local area network, an Intranet, or other private network, which may not accessible by the general public. Furthermore, the network 135 may represent a combination of public and private networks or a virtual private network (VPN).

The central profiler 110 may be configured to track the user's 140 activities oil the network 135 in a private and secure manner. Instead of using the user's 140 actual identification, the central profiler 110 may use a pseudonym for each user whose activities are being tracked. The central profiler 110 may cooperate with the pseudonym server 120 to obtain a pseudonym for the user 140 when the user 140 signs up for the privacy-preserving profiling service provided by the central profiler 110. Optionally, the central profiler 110 may provide the user 140 with a private key that can be used by the user 140 to release the user's 140 activities to a requesting party in a secure manner that reduces the risk of impersonation, for example, via well-known cryptographic mechanisms and techniques.

The pseudonym server 120 maybe configured to generate a pseudonym for the user 140 using conventional hash algorithms, such as the Secure Hash Algorithm (SHA-1), and/or the various Message Digest (MD2, MD4, MD5) algorithms. To ensure uniqueness of the generated pseudonyms, the pseudonym server 120 may use the salt server 125 to provide a “salt,” which may be random data that can be used in the hash algorithm.

The central profiler 110 may store the user's 140 pseudonym in the database 130, but may store the user's 140 actual identity separately (e.g., in different portions of the same database 130 or in a different database) to protect the user's 140 privacy. As the user 140 uses the network 135, the user's 140 activities may be stored in the database 130 and associated with the user's 140 pseudonym. These activities may be represented by keywords, which may be hashed, for example, by the pseudonym server 120 using salts and stored, for example, in the form of the resulting hashes, in the database 130. In this case, the keyword salts are not used to ensure uniqueness, but to better obscure the keyword hashes from intruders.

The pseudonym for the user 140 is provided to the external proxy server 115, which ensures that the user 140 is represented by the user's 140 associated pseudonym in any communications on the network 135. For example, in any communications between the user 140 and the external service 145, the external service 145 only has access to the user's 140 pseudonym and cannot obtain the user's 140 actual identity without the user's 140 permission. Moreover, the external proxy server 115 may provide the central profiler 110 with input on the user's 140 activities and/or the central profiler 110 may obtain input on the user's 140 activities directly from the user 140 and/or from a tracking capability within the network and/or within the device the user 140 uses to access the network.

Although FIG. 1 illustrates an exemplary communication network, it will be understood that the present invention is not limited to such configurations, but is intended to encompass any configuration capable of carrying out the operations described herein.

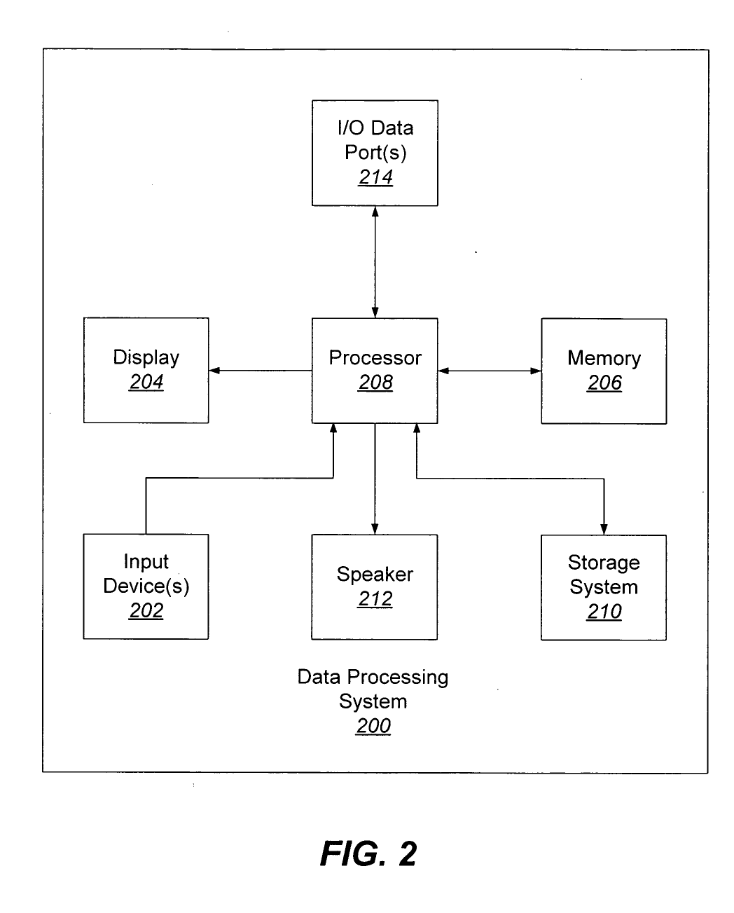

Referring now to FIG. 2, a data processing system 200 that may be used to implement the pseudonym server 120, salt server 125, central profiler 110, external proxy server 115, user 140, and/or external service 145 of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

Computer program code for carrying out operations of data processing systems discussed above with respect to FIGS. 1 and 2 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

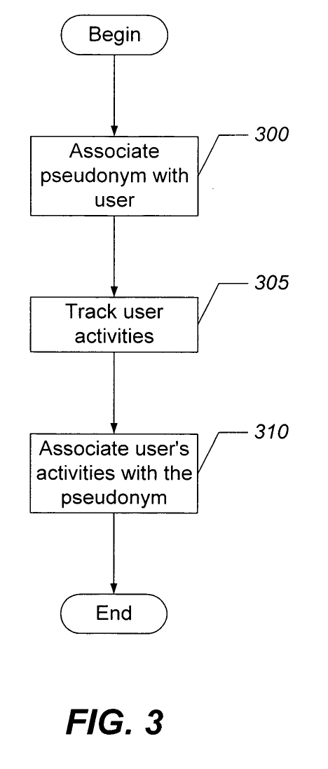

Exemplary operations for tracking and profiling network activities of a user and facilitating limited use of the collected information by external parties will now be described with reference to FIGS. 3 and 1. Operations begin at block 300 where the central profiler 110 associates a pseudonym obtained from the pseudonym server 120 with the user 140 and stores the pseudonym in the database 130. The central profiler 110 in cooperation with the external proxy server 115 tracks the user's 140 activities on the network 135 at block 305. The central profiler 110 associates the user's 140 activities in the form of keywords, for example, with the user's 140 pseudonym at block 310 and stores these keywords in the database 130.

In accordance with some embodiments of the present invention, the pseudonym server 120 hashes identification information of the user to form a pseudonym. To ensure uniqueness of the pseudonym, the pseudonym server 120 may combine salt from the salt server 125 with the user identification information and the combined salt and user identification information may be hashed to generate the pseudonym.

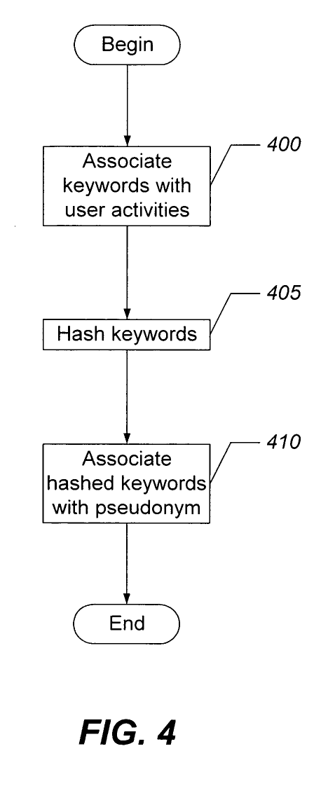

The user's 140 activities may be tracked by first obtaining from the user 140 a list of activities and/or services and/or types of activities and/or types of services that the central profiler 110 is authorized to track. The central profiler 110 in cooperation with the external proxy server 115 may only track those activities and/or services and/or types of activities and/or types of services that have been authorized by the user. 140. Referring now to FIG. 4, for those activities and/or services and/or types of activities and/or types of services that are tracked, the central profiler 110 associates keywords with the activities at block 400. In some embodiments, these keywords are hashed by the pseudonym server at block 405 and associated with the user's 140 pseudonym in the database 130 at block 410, for example, to provide a tracking record of the user's activities. In some embodiments of the present invention, the keywords may be hashed with salt data obtained from the salt server 125 for enhanced security. To associate the keywords with the user's activity, the keywords and/or hashes of the keywords may be stored with a time and date stamp and their frequency and/or number of instances may be recorded to reflect the number of occurrences of the activity.

The external service 145 may request information on the user's 140 use of the network 135 to provide improved service to the user 140. Note that in accordance with some embodiments of the present invention, the external service 145 does not know the user's 140 identity, but instead knows the user 140 by the user's pseudonym stored in the database 130, which may better protect the user's privacy. The central profiler 110 may receive a request for information on the user's 140 activities that includes one or more keywords of interest from the external service 145. The central profiler 110 provides the keywords of interest to the pseudonym server, which hashes those keywords of interest, along with any salts associated therewith if applicable. The hashes of the keywords of interest are compared with the keywords that are associated with the user's 140 pseudonym in the database 130. Via hash and re-hashing comparison techniques generally well-known in the art, the matching hashes are then re-associated with their corresponding keywords. If keyword hashing is not used, simple comparison of keywords of interest with user activity associated keywords may suffice. Upon pre-authorization of the user, the external service 145 is provided with an indication of which of the keywords of interest correspond to any of the actual keywords associated with the user's activities so that the external service 145 knows that the user 140 has been involved in those network activities associated with the matching keywords of interest.

In other embodiments, the central profiler 110 may evaluate the distribution of the keywords associated with the user's 140 pseudonym in the data base 130. Those keywords that have a frequency higher than a specified threshold may be reported to the external service 145 to inform the external service 145 that the user has used the network in the manner associated with the higher frequency keywords. The user 140 may also wish to inform the external service 145 about specific types of network activity and may identify certain keywords to be included on a preference list to be provided to the external service 145. The user 140 may also pre-identify certain keywords to always be provided to the external service 145 to inform the external service about those activities. Conversely, the user may select to not inform and/or to pre-identify keywords to never be provided.

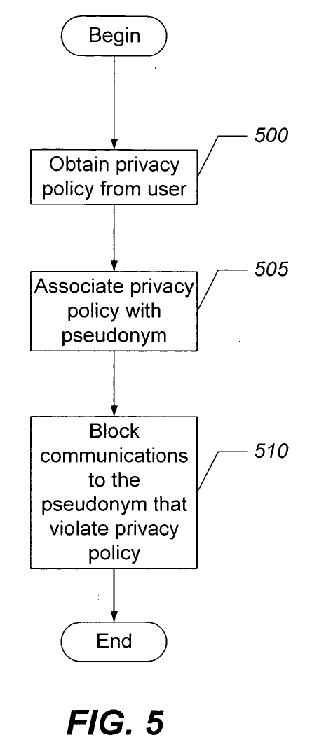

Referring now to FIG. 5, the user 140 may wish to restrict communications to and/or from another party, such as the external service 145. In this case, operations begin at block 500 where the central profiler obtains a privacy policy from the user 140. This policy is associated with the user's pseudonym at block 505 and communicated to the external proxy server 115. The external proxy server 115 may block communications to the user's 140 pseudonym that violate the user's 140 privacy policy and/or block communications containing user tracking results or other data to an external service 145. For example, the user 140 may wish to limit the number of advertisements received from the external service 145 to a specified number for a particular time period and/or wish to limit the occurrence or amount of activity tracking information provided to an external service 145.

The flowchart of FIGS. 3-5 illustrate the architecture, functionality, and operations of some embodiments of methods, systems, and computer program products for tracking and profiling network activities of a user and facilitating limited use of the collected information by external parties. In this regard, each block represents a module, segment, or portion of code, which comprises one or more executable instructions for implementing the specified logical function(s). It should also be noted that in other implementations, the function(s) noted in the blocks may occur out of the order noted in FIGS. 3-5. For example, two blocks shown in succession may, in fact, be executed substantially concurrently or the blocks may sometimes be executed in the reverse order, depending on the functionality involved.

Some embodiments of the present invention may be illustrated by way of example. A customer or user 140 may sign up with a privacy-preserving central profiling service through the central profiler 110. The user 140 may receive client software to assist in digitally signing messages and to setup individual preferences. The central profiler 110 in cooperation with the pseudonym server 120 and salt server 125 to set up a pseudonym for the user 140. The central profiler 110 in cooperation with the external proxy server 115 tracks the user's 140 activities on the network 135 in accordance with the user's 140 privacy settings. For each pertinent activity, the central profiler detects one or more keywords associated with the activity and/or detects the activity and assigns the corresponding keywords, and then hashes those keywords with salts for association with the user's 140 pseudonym and storage with time and date stamps and frequency or instance information in the database 130.

An external service 145, such as a bookstore, requests a partial profile for the user's 140 pseudonym. The central profiler performs hash comparisons for keywords of interest provided by the external service 145 to determine if any matches exist. A match does exist, re-hashing comparisons are done to determine corresponding keywords, keywords are sent by the external proxy 115 to the external service 145, and the external service 145 then sends ads related to the user's 140 activities to the user 140 via the user's pseudonym. The external proxy server 115 may limit the number of these ads in accordance with a privacy policy established by the user 140.

The user 140 receives a promotion from the external service 145 and decides that the external service can be trusted with his/her identity. The user 140 uses his/her private key, via well known authentication/authorization/encryption/digital signing mechanisms and techniques, to authorize the central profiler to release his/her actual identity to the external service 145.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
associating a pseudonym with a user of the communication network;
tracking the user's activities on the communication network; and
associating the user's activities with the pseudonym.

2. The method of claim 1, wherein associating the pseudonym comprises:
hashing identification information of the user to generate the pseudonym.

3. The method of claim 2, wherein hashing identification information comprises:
hashing identification information of the user with salt data to generate the pseudonym.

4. The method of claim 1, wherein tracking the user's activities comprises:
obtaining an identification of authorized activities to be tracked from the user; and
tracking the user's authorized activities on the communication network.

5. The method of claim 1, wherein tracking the user's activities comprises:
associating keywords with the user's activities on the communication network;
hashing the keywords; and
associating the hashes of the keywords with the pseudonym.

6. The method of claim 5, wherein hashing the keywords comprises:
hashing the keywords with salt data.

7. The method of claim 5, further comprising:
receiving a request for information on the user's activities that comprises keywords of interest from a requester;
hashing the keywords of interest;
comparing the hashes of the keywords of interest with the hashes of the keywords associated with the pseudonym;
determining if any of the keywords of interest correspond to any of the keywords associated with the user's activities based on the comparison of the hashes of the keywords of interest with the hashes of the keywords associated with the pseudonym; and
providing the requester with an indication of which of the keywords of interest correspond to any of the keywords associated with the user's activities.

8. The method of claim 5, further comprising:
receiving a request for information on the user's activities from a requestor;
evaluating a distribution of instances of the keywords associated with the user's activities to identify those keywords having a frequency that is higher than a threshold; and
providing the requestor with those keywords having the frequency that is higher than the threshold, a preference list of keywords associated with the user, and/or pre-identified keywords associated with the user's activities.

9. The method of claim 1, further comprising:
obtaining a privacy policy from the user;
associating the privacy policy with the pseudonym; and
blocking communications to the pseudonym and/or to an external service that violate the privacy policy.

10. A communication network, comprising:
a pseudonym server that is configured to generate a pseudonym that is associated with a user of the network; and
a central profiler that is configured to track the user's activities on the communication network and associate the user's activities with the pseudonym.

11. The communication network of claim 10, wherein the pseudonym server is further configured to hash identification information of the user to generate the pseudonym.

12. The communication network of claim 11, further comprising:
a salt server; and
wherein the pseudonym server is further configured to hash identification information of the user with salt data provided by the salt server to generate the pseudonym.

13. The communication network of claim 10, wherein the central profiler is further configured to associate hashes of the keywords with the user's activities on the communication network.

14. The communication network of claim 13, further comprising:
a salt server; and
wherein the pseudonym server is further configured to hash the keywords with salt data provided by the salt server to generate the hashes of the keywords.

15. The communication network of claim 10, wherein the pseudonym server is further configured to hash keywords of interest contained in a request for information from a requestor; and wherein the central profiler is further configured to compare the hashes of the keywords of interest with the hashes of the keywords associated with the pseudonym, determine if any of the keywords of interest correspond to any of the keywords associated with the user's activities based on the comparison of the hashes of the keywords of interest with the hashes of the keywords associated with the pseudonym, and provide the requestor with an indication of which of the keywords of interest correspond to any of the keywords associated with the user's activities.

16. The communication network of claim 10, wherein the central profiler is further configured to receive a request for information on the user's activities from a requestor, evaluate a distribution of instances of the keywords associated with the user's activities to identify those keywords having a frequency that is higher than a threshold, and provide the requestor with those keywords having the frequency that is higher than the threshold, a preference list of keywords associated with the user, and/or pre-identified keywords associated with the user's activities.

17. The communication network of claim 10, wherein the central profiler is further configured to obtain a privacy policy from the user and to associate the privacy policy with the pseudonym; and wherein the communication network further comprises:
an external proxy server that is connected to the central profiler and is configured to block communications to the pseudonym and/or to an external service that violate the privacy policy.

18. A computer program product for operating a communications network, comprising:
a computer readable storage medium having computer readable program code embodied therein, the computer readable program code comprising:
computer readable program code configured to associate a pseudonym with a user of the communication network;
computer readable program code configured to track the user's activities on the communication network; and
computer readable program code configured to associate the user's activities with the pseudonym.

19. The computer program product of claim 18, wherein the computer readable program code configured to track the user's activities comprises:
computer readable program code configured to associate keywords with the user's activities on the communication network;
computer readable program code configured to hash the keywords; and
computer readable program code configured to associate the hashes of the keywords with the pseudonym.

20. The computer program product of claim 18, further comprising:
computer readable program code configured to obtain a privacy policy from the user;
computer readable program code configured to associate the privacy policy with the pseudonym; and
computer readable program code configured to block communications to the pseudonym and/or to an external service that violate the privacy policy.
